(19) United States
(12) Patent Application Publication
(10) Pub. No.: US 2026/0010881 A1
(43) Pub. Date: Jan. 8, 2026

(54) TOOLS TO CREATE FINANCIAL TRANSACTION MESSAGES MAPPED TO VARIOUS USE CASES

(71) Applicant: JP Morgan Chase Bank, N.A., New York, NY (US)

(72) Inventor: Michael TUDOR, Bournemouth (GB)

(73) Assignee: JP Morgan Chase Bank, N.A., New York, NY (US)

(21) Appl. No.: 18/763,923

(22) Filed: Jul. 3, 2024

(51) Int. Cl. G06Q 20/10; G06N 20/00

(52) U.S. Cl. CPC G06Q 20/10; G06N 20/00

(57) ABSTRACT

Apparatus is provided including computer memory configured to hold messages including data structures and configured data. The data structures may comprise a markup language and file format organized in accordance with a tree structure. The data structures may comprise an MX/ISO 20022 messaging format payment file for a sent or received payment. A machine learning (ML) processing circuit is provided that comprises a prediction data input and is configured to receive various messages at the prediction data input and to hold the various messages in the computer memory. The ML processing circuit comprises a message generator configured to generate messages for use in other systems, the generated messages being configured in accordance with the data structures. Per another embodiment, the machine learning processing circuit may be configured to create test messages based on the various messages held in the computer memory.

### TECHNICAL FIELD

Aspects of the disclosure relate to creating messages under the International Organization for Standardization (ISO) 20022 messaging schema. Other aspects of the disclosure relate to creating test data under the ISO 20022 messaging schema, for testing in various contexts.

### BACKGROUND

Creating valid messages under the ISO 20022 approach for financial transactions and activity is challenging. A human individual must manually create a massive ISO 20022-compliant extensible markup language (XML) message file (sometimes referred to as an XM message) from a flat text file. This endeavor is complex and may require receiving and validating large amounts of data from upstream systems for inclusion in an XM/ISO 20022 message.

Up to approximately 3.5 thousand mandatory and optional tags will need to be checked for conformance to validity constraints on data elements. These tags, for example, may include the length of a data element, its format, the logic employed by a portion of a message, when and how the message element is used, and restrictions on who can populate certain aspects of a given message. There is a need for a process to make the creation of XM/ISO 20022 messages with less effort, for example, for testing in various contexts such as in downstream ISO 20022 systems.

### SUMMARY

An objective of the disclosure is to automate at least portions of the process of creating ISO 20022 test messages. Another objective of the disclosure is to automate at least portions of the process of creating ISO 20022 messages for use in actual operation or (in the form of test messages) in a test environment, for example, in different use cases. Another objective of the disclosure is to monitor payments and identify trends in the quality of those payments (reductions and improvements in quality), for example, in order to provide advanced warning of potential production incidents.

One or more alternate or additional objectives may be served by the present disclosure, for example, as may be apparent by the following description. Embodiments of the disclosure include any apparatus, machine, system, method, articles (e.g., computer-readable media encoded to cause certain acts), or any one or more sub-parts or sub-combinations of such apparatus (singular or plural), system, method, or article (or encoding thereon or therein), for example, as supported by the present disclosure. Embodiments herein also contemplate that any one or more processes as described herein may be incorporated into a processing circuit.

In accordance with one embodiment, an apparatus is provided including computer memory configured to non-transiently hold messages including data structures, and configured data configured in accordance with the data structures. The data structures may comprise a markup language and file format organized in accordance with a tree structure. More specifically, the data structures may comprise an MX/ISO 20022 messaging format payment file for a sent or received payment. A machine learning (ML) processing circuit is provided that comprises a prediction data input and is configured to receive various messages at the prediction data input and to hold the various messages in the computer memory. The ML processing circuit comprises a message generator configured to generate messages for use in other systems, where the generated messages are configured in accordance with the data structures.

A test data designator may be provided per another embodiment, which is configured to create test messages from the various messages held in the computer memory. The test data designator may be further configured to map at least select ones of the test messages to use cases.

The computer memory may comprise a feature store per a more specific embodiment, where the feature store comprises feature reference data comprising features and feature values used by the ML processing circuit for inferencing. The feature reference data may also be used for training in select embodiments. The feature store may further include biasing prior knowledge data and may also include use case contextual data.

Per one embodiment, the ML processing circuit is configured to implement a ML model comprising a decision tree. More specifically, the ML model may comprise a random forest algorithm involving decision trees. Alternatively, the ML model may comprise a Naive Bayes classifier. The Naive Bayes classifier may be accompanied by one or more decision trees.

Per another embodiment, a method may be provided whereby a computer memory holds messages including data structures and configured data configured in accordance with the data structures, and whereby a ML process is carried out. The ML process includes receiving various messages at a prediction data input and holding the various messages in the computer memory.

Per another embodiment, non-transient computer-readable media is provided encoded to cause a computer memory to hold messages including data structures, and configured data configured in accordance with the data structures. The media is further encoded to cause an ML process to be carried out. The ML process includes receiving various messages at a prediction data input and holding the various messages in the computer memory.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a block diagram depicting a process and system for test data generation in accordance with one embodiment;

FIG. 2 is a block diagram showing a ML processor and its process;

FIG. 3 is a flow chart of a model process; and

FIG. 4 is a block diagram of an example computer controller.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

In accordance with one or more embodiments herein, various terms may be defined as follows.

Application program. An application program is a program that, when executed, involves user interaction, whereas an operating system program, when executed, serves as an interface between an application program and the underlying hardware of a computer. Any one or more of the various acts described below may be carried out by a program, e.g., an application program and/or operating system program.

Processing circuit. A processing circuit may include both (at least a portion of) computer-readable media carrying functional encoded data and components of an operable computer. The operable computer is capable of executing (or is already executing) the functional encoded data, and thereby is configured when operable to cause certain acts to occur. A processing circuit may also include: a machine or part of a machine that is specially configured to carry out a process, for example, any process described herein; or a special purpose computer or a part of a special purpose computer.

A processing circuit may also be in the form of a general-purpose computer running a compiled, interpretable, or compilable program (or part of such a program) that is combined with hardware carrying out a process or a set of processes. A processing circuit may further be implemented in the form of an application-specific integrated circuit (ASIC), part of an ASIC, or a group of ASICs. A processing circuit may further include an electronic circuit or part of an electronic circuit. A processing circuit does not exist in the form of code per se, software per se, instructions per se, mental thoughts alone, or processes that are carried out manually by a person without any involvement of a machine.

Program. A program includes software for a processing circuit.

User interface tools; user interface elements; output user interface; input user interface; input/output user interface; and graphical user interface tools. User interface tools are human user interface elements that allow human user and machine interaction, whereby a machine communicates to a human (output user interface tools), a human inputs data, a command, or a signal to a machine (input user interface tools), or a machine communicates, to a human, information indicating what the human may input, and the human inputs to the machine (input/output user interface tools).

Graphical user interface tools (graphical tools) include graphical input user interface tools (graphical input tools), graphical output user interface tools (graphical output tools), and/or graphical input/output user interface tools (graphical input/output tools). A graphical input tool is a portion of a graphical screen device (e.g., a display and circuitry driving the display) configured to, via an on-screen interface (e.g., with a touchscreen sensor, with keys of a keypad, a keyboard, etc., and/or with a screen pointer element controllable with a mouse, toggle, or wheel), visually communicate to a user data to be input and to visually and interactively communicate to the user the device's receipt of the input data.

A graphical output tool is a portion of a device configured to, via an on-screen interface, visually communicate to a user information output by a device or application. A graphical input/output tool acts as both a graphical input tool and a graphical output tool. A graphical input and/or output tool may include, for example, screen-displayed icons, buttons, forms, or fields. Each time a user interfaces with a device, program, or system in the present disclosure, the interaction may involve any version of user interface tool as described above, e.g., which may be a graphical user interface tool.

As noted above, aspects of the present disclosure relate to messaging under the ISO 20022 messaging schema. ISO 20022 is a new global financial messaging standard. Messages under this new standard, sometimes called MX messages, are meant to replace traditional SWIFT messages, called MT messages.

The embodiments disclosed herein allow for the creation of actual messages for use in financial transactions among real operational systems, or they allow for the more specific creation of test messages, for example, for use with payments flow simulations, whereby one or more partner applications sends and receives and validates the test messages.

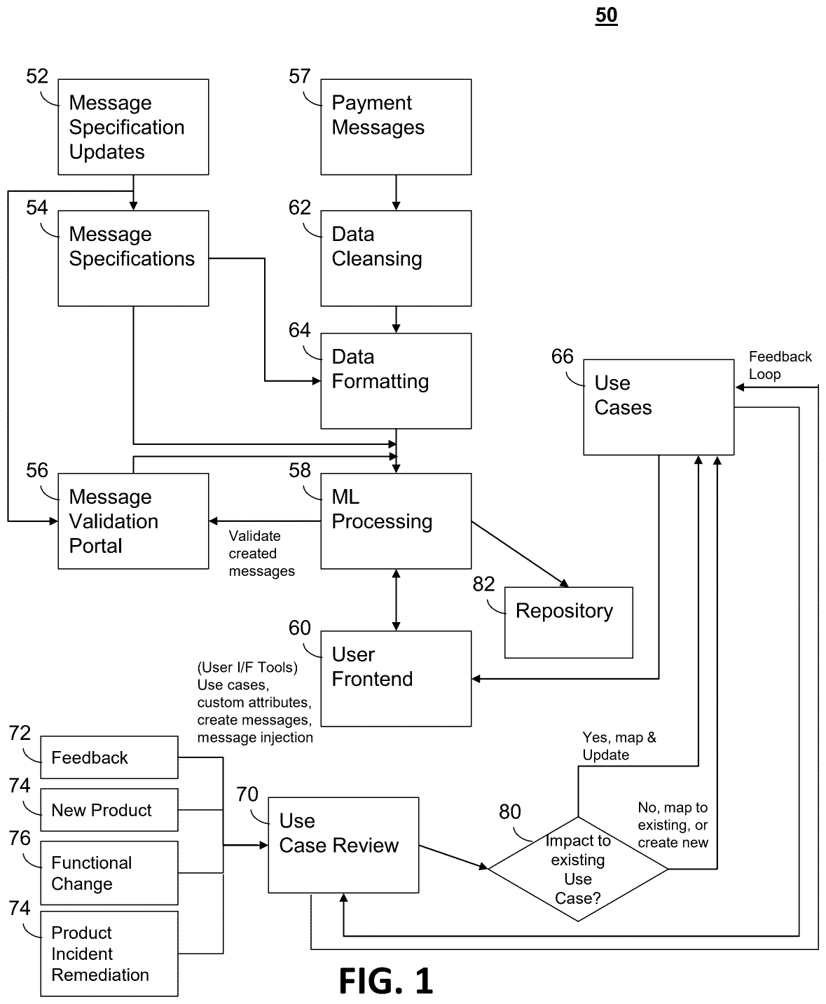

Referring now to the drawings in greater detail, FIG. 1 is a flow diagram of a test data generator process or system 50. At block 57, sample payment messages in proper XM format are obtained from production data from actual financial transactions of a given institution. These samples may, for example, be obtained using bootstrap sampling. At block 62, data cleansing is performed on the sampled messages. In this step, the XM data is cleaned so that it is easily understood by either a human or a machine. This may be done with an automated process, manually, or with a combination of automated processing and human input.

Next, at block 64, the cleansed sampled messages are subjected to data formatting. In this step, the messages are put into an interim format helpful to the model in the ML processing that will be performed on the samples. Here, for each message record, several associated features and feature values or feature value open fields are established and populated. At least some of these features have feature value open fields associated with them because other data will be required to determine those feature values which will be added by the ML process at block 58 as described below.

For example, one feature associated with a given sample message may be the number of Swift validation rules that apply to the given sample message, which requires access to Swift message specifications provided from the Swift portal at block 54 and input to the machine language process as indicated from the arrow into block 58.

At block 52, updates are provided to the message specifications as shown by an arrow into block 54. This may occur, for example, when there are new message types or due to market infrastructure changes or additions. This information is also input to the message validation portal as shown by an arrow into block 56. The message validation portal is provided by Swift and is shown at block 56. Machine learning process 58 sends messages it is creating or sample messages that it is using for training to the message validation portal at block 56.

In select embodiments, the message validation portal may be configured to include a graphical user interface provided on top of XML schema validations. Accordingly, message validation may involve use of the portal or systemic means and may include schema validations.

Then, via a model feedback loop, the validation information is returned to the ML process at block 58. This message validation information may include for a given message, for example, valid, warning invalid, and invalid indications for one or more lines in the given message. The message validation information provided to the ML process may also include specific warning or error messages pertaining to each indication, an explanation, and the corresponding impacted lines of the message.

Messages and corresponding information are output by the ML process. This information is provided to the user front end at block 60 and may also be stored in repository 82. The repository 82 may be accessed to obtain trend information regarding the quality of the MX messages created by the ML process.

The user front end may be provided with one or more user interface tools and associated application programs. These tools and programs allow a user to select one or more use cases for the desired one or more test messages to be created by the ML process, and for initiating the creation of the test messages. A user interface tool may be provided for specifying one or more custom attributes of the test messages to be created.

For example, the user may specify if the test message is to contain a certain type of error failing to comply with Swift requirements or failing to comply with a third-party system to be interfaced with when deploying the message. In addition, the user front end may also be configured to allow for the injection of one or more messages to be embedded in a given MX test message, which embedded message may be specified by an interface tool.

The data included in the data formatting at block 64 may also be provided with associated use case data, due to use case mapping to sample payment messages. Those mapped use cases are obtained in the illustrated process from use cases at block 66. A process may be employed for creating, revising, and reviewing use cases, whereby feedback (at block 72), new product offerings (at block 74), functional changes (at block 76), product incident remediation (at block 78) each may contribute to a new use case or a revision to a use case.

Use case review is shown at block 70. The use case review process at block 70 may receive the use cases via input from block 66. Each time there is a new or revised use case at the use case review block 70, a feedback loop input may be provided from use case review (block 70) to use cases (block 66). The feedback loop facilitates conducting a review and recertification of a given use case.

A decision is made at block 80 when a new or revised use case is provided to determine whether a given change or input from the use case review results in an impact to an existing use case. If there is such an impact, the appropriate use case or use cases will be updated and mapped to corresponding sample messages accordingly. If there is not such an impact, either the update will be mapped to one or more existing use cases, or one or more new use cases will be created. As shown, use cases block 66 will also provide an input to the user front end 60 to allow users to consider and take actions for purposes of creating enhancements and enabling testing of new or updated use cases.

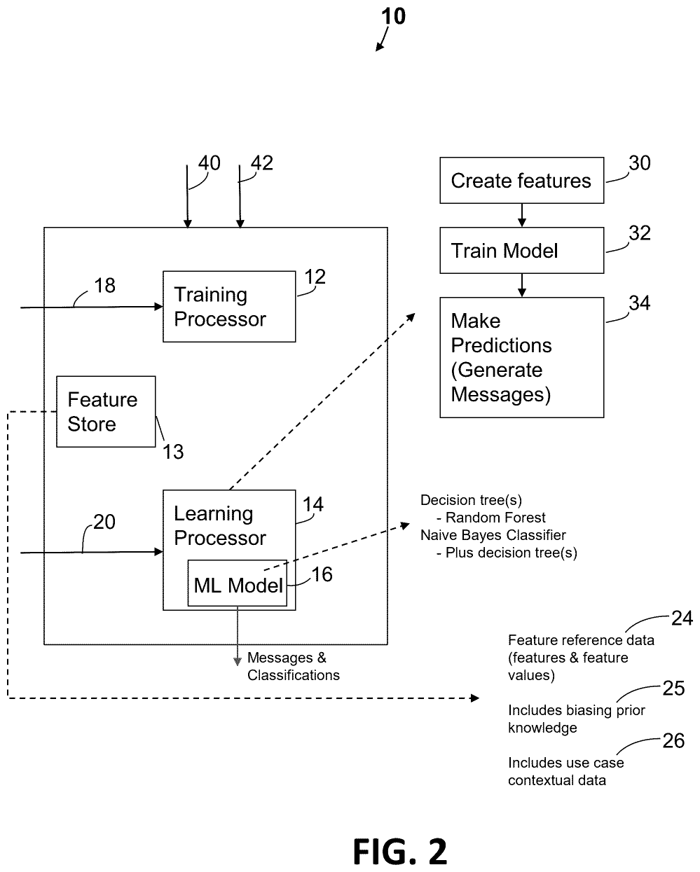

FIG. 2 shows a block diagram of an embodiment of an ML processing layer 10 to implement the ML process 58 of FIG. 1. The illustrated ML processing layer 10 includes a training processor 12, a feature store 13, and a learning processor 14. The learning processor 14 includes an ML model 16. Training data is input to the training processor 12 via training data input 18. Prediction data is input to the learning processor 14 via prediction data input 20.

The training processor 12 provides sample messages, labels, and associated data (for example, use case contextual data) to the learning processor 14. The learning processor 14 provides, as its output, at least one or more test messages and classifications. In some embodiments, the learning processor 14 may be configured for generating MX messages for actual use in operation. Per one embodiment, candidate messages input at the prediction data input 20 are provided by the user via one or more user interface tools at the user front end 60 in FIG. 1.

As shown, the feature store 13 may include feature reference data 24, which includes features and associated feature values. These features and feature values are used for model training by the training processor 12 and used for inferencing by the learning processor 14. Feature store 13 may also include biasing prior knowledge data 25 (for inductive bias employed by learning processor 14). This data may include live data, historical data, and/or contextual data. The feature store 13 may also include use case contextual data 26, which includes data about use cases and mapping information for purposes of mapping to sample and/or predicted MX messages.

The learning processor 14 may be configured to carry out online or batch learning protocols, or a combination of the two. The training and learning by the training processor 12 and the learning processor 14 are performed pursuant to the ML model 16. In operation, the learning processor 14 carries out a process shown by blocks 30, 32, and 34. Here, features are created or populated from raw data at block 30, the ML model 16 is trained at block 32, and predictions (the output messages and classifications) are made on new data at block 34.

Training may be supervised, where there is human involvement to specify labels associated with input sample messages. Alternatively, training may be unsupervised, where labels are provided automatically, and training occurs without human input.

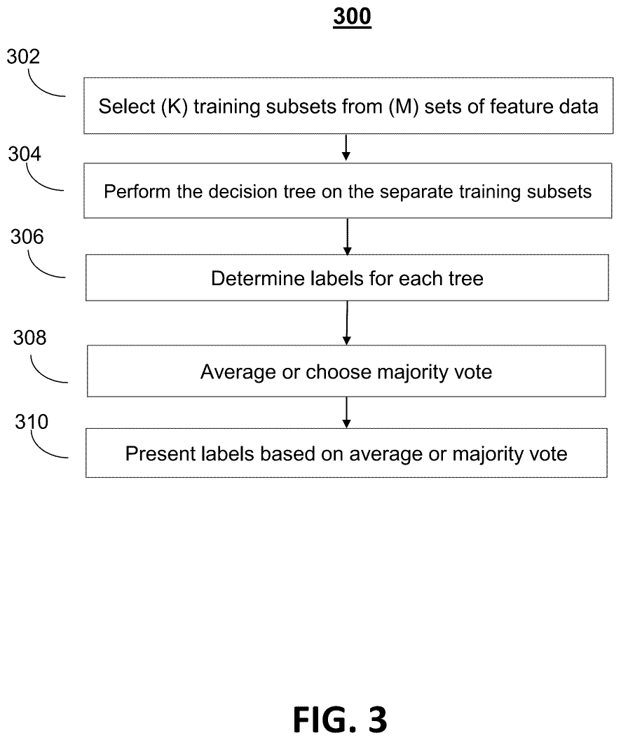

The ML model 16 may comprise one or more decision trees and may employ a random forest algorithm, for example, as shown in FIG. 3 and further described below. Per another embodiment, the ML model 16 may employ a Naive Bayes classifier. In some embodiments, the Naive Bayes classifier may be accompanied by one or more decision trees, for example, including a random forest algorithm.

In these embodiments of the ML processing layer 10, sample messages input to the training processor 12, along with output predicted MX messages, have several accompanying features. As one example, those features may include the following:
a) F1. Total previous validation errors for this message;
b) F2. Total other system previously returned errors for this message;
c) F3. Total previous validation warning messages for this message;
d) F4. Total other system returned warning messages for this message;
e) F5. Number of validation rules that apply to this message;
f) F6. Number of times that Swift rules apply to this message; and
g) F7. Number of times that certain critical validation rules apply to this message.

A message validation input 40 may be provided whereby model feedback information from a message validation portion is input to the ML processing layer 10, in the manner and for the purposes described above with reference to FIG. 1. A message specification input 42 may be provided whereby message specifications are input to the ML processing layer 10, in the manner and for the purposes described above with reference to FIG. 1.

FIG. 3 shows an example model algorithm 300, employing a random forest algorithm. In block 302, K training subsets are selected from M sets of feature data from among M sample messages. For example, the K training sets may be determined using the bagging method, whereby K subsets are randomly selected from the M sets of training data. Then, in block 304, a decision tree is performed on the separate training subsets. In block 306, the labels (predicted data) are determined for each tree. In block 308, the predicted data to be presented is determined by averaging, or by a majority vote. In block 310, the model presents the labels determined in block 308.

Per one embodiment, each test message is accompanied by three types of responses: a predicted error, no error, or warning classification. An example of a decision tree for classifying a given message among these types of responses is to determine the sum of the total values for the features F1, F2, F3, and F4 for the given message. If the sum is below a lower threshold, the message will be predicted to have no errors. If the sum is between a lower threshold and a higher threshold, the message will be predicted to have an error warning. If the sum is above the higher threshold, the message will be predicted to have an error.

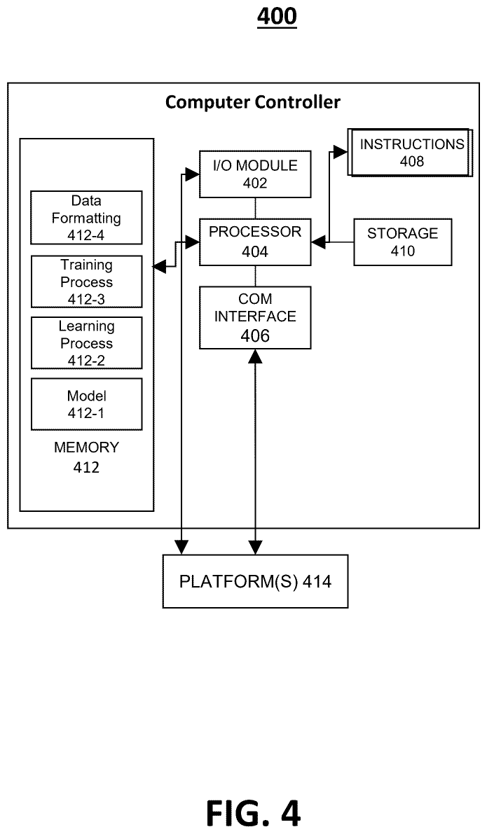

FIG. 4 illustrates a computer controller 400 that may be an application-specific hardware, software, and firmware implementation of the ML processing layer 10 in FIG. 2 and/or the test data generator process 50 of FIG. 2, described above. The controller 400 may include a processor 404 configured to be executed on one or more, or all of the blocks of the system of FIGS. 1 and 2, or the functions of the test data generator process 50 or the ML processing layer 10, described above.

The processor 404 can have a specific structure imparted to the processor 404 by instructions stored in the memory 412 and/or by instructions 408 fetchable by the processor 404 from a storage medium 410. The storage medium 410 can be remote and communicatively coupled to the controller 400.

The controller 400 can be a stand-alone programmable system, or a programmable module included in a larger system. For example, the controller 400 may include or be connected with the ML processing layer 10. For example, the controller 400 may include one or more hardware and/or software components configured to fetch, decode, execute, store, analyze, distribute, evaluate, and/or categorize information.

The processor 404 may include one or more processing devices or cores (not shown). In some embodiments, the processor 404 may be a plurality of processors, each having one or more cores. The processor 404, in another embodiment, may be a distributed processor. The processor 404 can execute instructions fetched from the memory 412, i.e., with reference to, among other code, instructions or data, one of memory modules 412-1, 412-2, 412-3, or 412-4. Alternatively, the instructions can be fetched from the storage medium 410, or from a remote device connected to the controller 400 via the communication interface 406.

Furthermore, the communication interface 406 can also interface with computer systems within a computer system of the ML processing layer 10. An input/output (I/O) module 402 may be configured for additional communications to or from associated local and/or remote systems of one or more platforms 414 of the ML processing layer 10.

Without loss of generality, the storage medium 410 and/or the memory 412 can include a volatile or non-volatile, magnetic, semiconductor, tape, optical, removable, non-removable, read-only, random-access, or any type of non-transitory computer-readable computer medium. The storage medium 410 and/or the memory 412 may include programs and/or other information usable by processor 404. Furthermore, the storage medium 410 can be configured to log data processed, recorded, or collected during the operation of the controller 400.

The data may be time-stamped, location-stamped, cataloged, indexed, encrypted, and/or organized in a variety of ways consistent with data storage practice. The memory modules in memory 412 may represent specialized modules for various functions described in the embodiments herein. By way of example, the memory module 412-1 may represent a specialized module configured to implement aspects of the model described above. Similarly, the memory module 412-2 may form a specialized learning process module, the memory module 412-3 may form a specialized training process module, and the memory module 412-4 may form a specialized data formatting module. The instructions embodied in these memory modules can cause the processor 404 to perform certain operations consistent with the functions described above.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

While the foregoing is directed to embodiments of the present disclosure, other and further embodiments of the disclosure may be devised without departing from the basic scope thereof, and the scope thereof is determined by the claims that follow.

What is claimed is:

1. Apparatus comprising:
computer memory configured to non-transiently hold messages including data structures and configured data configured in accordance with the data structures; and
a machine learning processing circuit comprising a prediction data input and configured to receive various messages at the prediction data input and to hold the various messages in the computer memory, the machine learning processing circuit comprising a message generator configured to generate messages for use in other systems, the generated messages being configured in accordance with the data structures.

2. The apparatus according to claim 1, wherein the data structures include a markup language and file format organized in accordance with a tree structure.

3. The apparatus according to claim 2, wherein the data structures include an MX/ISO (international organization for standardization) 20022 messaging format representing a payment file for a sent or received payment.

4. The apparatus according to claim 3, wherein the machine learning processing circuit further comprises a training input and is configured to receive training messages at the training input and to hold the training messages in the computer memory.

5. The apparatus according to claim 4, wherein the generated messages comprise test messages created based on the various messages held in the computer memory.

6. The apparatus according to claim 5, wherein the machine learning processing circuit is further configured to map at least one of the test messages to use cases.

7. The apparatus according to claim 3, wherein the computer memory comprises a feature store comprising feature reference data comprising features and feature values used by the machine learning processing circuit for inferencing.

8. The apparatus according to claim 7, wherein the feature reference data is also used by the machine learning processing circuit for training.

9. The apparatus according to claim 8, wherein the feature store further comprises biasing prior knowledge data.

10. The apparatus according to claim 9, wherein the feature store further comprises use case contextual data.

11. The apparatus according to claim 4, wherein the machine learning processing circuit is configured to implement a machine learning model comprising a decision tree.

12. The apparatus according to claim 11, wherein the machine learning model further comprises a random forest algorithm.

13. The apparatus according to claim 4, wherein the machine learning processing circuit is configured to implement a machine learning model comprising a Naive Bayes classifier.

14. The apparatus according to claim 13, wherein the machine learning model further comprises one or more decision trees.

15. A method comprising:
a computer memory holding messages including data structures and configured data configured in accordance with the data structures;
a machine learning process being carried out, the machine learning process including receiving various messages at a prediction data input, and holding the various messages in the computer memory; and
the machine learning process generating messages for use in other systems, the generated messages being configured in accordance with the data structures.

16. The method according to claim 15, further comprising creating test messages based on the various messages held in the computer memory.

17. The method according to claim 16, further comprising mapping at least select ones of the test messages to use cases.

18. A non-transient computer-readable media encoded to cause:
a computer memory holding messages including data structures and configured data configured in accordance with the data structures;
a machine learning process being carried out, the machine learning process including receiving various messages at a prediction data input, and holding the various messages in the computer memory; and
the machine learning process generating messages for use in other systems, the generated messages being configured in accordance with the data structures.

19. The media according to claim 18, encoded to further cause creating test messages based on the various messages held in the computer memory.

20. The media according to claim 19, encoded to further cause mapping at least select ones of the test messages to use cases.
